(19) United States
(12) Patent Application Publication
(10) Pub. No.: US 2023/0161197 A1
(43) Pub. Date: May 25, 2023

(54) BACKLIGHTS INCLUDING PATTERNED REFLECTORS

(71) Applicants: CORNING INCORPORATED, CORNING, NY (US); CORNING PRECISION MATERIALS CO. LTD, Asan-si (KR)

(72) Inventors: GUANGLEI DU, PITTSFORD, NY (US); JOON-SOO KIM, Yongin-si (KR)

(21) Appl. No.: 17/920,941

(22) PCT Filed: Apr. 13, 2021
(86) PCT No.: PCT/US2021/027004

§ 371 Date: Oct. 24, 2022

Related U.S. Application Data
(60) Provisional application No. 63/016,503, filed on Apr. 28, 2020.

(51) Int. Cl. G02F 1/13357

(52) U.S. Cl. CPC G02F 1/133606; G02F 1/133605

(57) ABSTRACT

A backlight that includes a plurality of light sources coupled to a substrate, and a patterned diffuser over the plurality of light sources is disclosed. The patterned diffuser including a plurality of patterned reflectors coupled to a patterned diffuser body, where each patterned reflector is positioned to align with a corresponding light source. The backlight has a longitudinal direction, and the substrate and the patterned diffuser body have a maximum longitudinal substrate dimension (L_{Max,S}) and a maximum longitudinal patterned diffuser body dimension (L_{Max,PDB}), respectively, in the longitudinal direction. The backlight has a thermal alignment tolerance in the longitudinal direction at 60° C. is 500 microns or less, where the thermal alignment tolerance at the 60° C. is the absolute value of [the smaller of L_{Max,S} and L_{Max,PDB]} x [60° C. - 23.5° C. (room temperature)] x [substrate coefficient of thermal expansion (CTE_{S}) - light guide plate coefficient of thermal expansion (CTE_{PDB})].

### CROSS-REFERENCE TO RELATED APPLICATION

This application claims the benefit of priority under 35 U.S.C. § 119 of U.S. Provisional Application Serial No. 63/016503 filed on Apr. 28, 2020, the content of which is relied upon and incorporated herein by reference in its entirety.

### FIELD

The present disclosure relates generally to backlights for displays. More particularly, it relates to backlights including patterned reflectors and/or a diffusive layer.

### TECHNICAL BACKGROUND

Liquid crystal displays (LCDs) are commonly used in various electronics, such as cell phones, laptops, electronic tablets, televisions, and computer monitors. LCDs are light valve-based displays in which the display panel includes an array of individually addressable light valves. LCDs may include a backlight for producing light that may then be wavelength converted, filtered, and/or polarized to produce an image from the LCD. Backlights may be edge-lit or direct-lit. Edge-lit backlights may include a light emitting diode (LED) array edge-coupled to a light guide plate that emits light from its surface. Direct-lit backlights may include a two-dimensional (2D) array of LEDs directly behind the LCD panel.

Direct-lit backlights may have the advantage of improved dynamic contrast as compared to edge-lit backlights. For example, a display with a direct-lit backlight may independently adjust the brightness of each LED to set the dynamic range of the brightness across the image. This is commonly known as local dimming. To achieve desired light uniformity and/or to avoid hot spots in direct-lit backlights, however, a diffuser plate or film may be positioned at a distance from the LEDs, thus making the overall display thickness greater than that of an edge-lit backlight. Lenses positioned over the LEDs have been used to improve the lateral spread of light in direct-lit backlights. The optical distance (OD) between the LEDs and the diffuser plate or film in such configurations (e.g., from at least 10 to typically about 20-30 millimeters), however, still results in an undesirably high overall display thickness and/or these configurations may produce undesirable optical losses as the backlight thickness is decreased. While edge-lit backlights may be thinner, the light from each LED may spread across a large region of the light guide plate such that turning off individual LEDs or groups of LEDs may have only a minimal impact on the dynamic contrast ratio.

### SUMMARY

In some embodiments of the present disclosure, a backlight that includes a plurality of light sources coupled to a substrate, and a patterned diffuser over the plurality of light sources is disclosed. The patterned diffuser including a plurality of patterned reflectors coupled to a patterned diffuser body, where each patterned reflector is aligned with a corresponding light source. The backlight extends along a longitudinal direction, and the substrate has a maximum longitudinal substrate dimension (L_{Max},S) and the patterned diffuser body has a maximum longitudinal patterned diffuser body dimension (L_{Max},_{PDB}), each of L_{Max},_{S} and L_{Max},_{PDB}, respectively, measured in the longitudinal direction. The backlight has a thermal alignment tolerance in the longitudinal direction at 60° C. is 500 microns or less, where the thermal alignment tolerance at the 60° C. is the absolute value of [the smaller of L_{Max},_{S} and L_{Max},_{PDB]} x [60° C. - 23.5° C. (room temperature)] x [substrate coefficient of thermal expansion (CTEₛ) - light guide plate coefficient of thermal expansion (CTE_{PDB})].

Some embodiments of the present disclosure relate to a backlight each light source includes a size measured in a plane parallel to the longitudinal direction. Each patterned reflector is aligned with a corresponding light source and includes a thickness profile. The thickness profile includes a substantially flat section and a curved section extending from and surrounding the substantially flat section. The substantially flat section varies in thickness by no more than plus or minus 20 percent of an average thickness of the substantially flat section. The substantially flat section includes a size in a plane parallel to the longitudinal direction equal to or greater than the size of each light source.

Yet other embodiments of the present disclosure relate to a backlight where each patterned reflector is aligned with a corresponding light source and includes a first solid section, a plurality of second solid sections surrounding the first solid section, and a plurality of open sections interleaved with the plurality of second solid sections. The first solid section includes a size in a plane parallel to the longitudinal direction to or greater than the size of each light source.

Yet other embodiments of the present disclosure relate to a backlight where each patterned reflector is aligned with a corresponding light source and includes a solid first section, a second section surrounding the solid first section, and a plurality of openings extending through the second section. The openings increase in size as a distance from a center of the solid first section increases. The solid first section includes a size in a plane parallel to the longitudinal direction equal to or greater than the size of each light source.

The backlights disclosed herein are thin direct-lit backlights with improved light efficiency. The backlights have an improved ability to hide light sources resulting in a thinner backlight. The improved ability to hide the light sources allows for the removal of so-called “hot” spots directly above the light sources of the backlight, thus resulting in a uniform brightness across the display. Furthermore, the construction of the backlights described herein provide for the manufacture of large backlight panels while maintaining these properties across a range of operating temperatures.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiment(s), and together with the description explain principles and operation of the various embodiments.

### BRIEF DESCRIPTION OF THE DRAWINGS

FIG. 1A is top view of a backlight as described herein.

FIG. 1B is a cross-sectional view of the backlight of FIG. 1A taken along cut line A-A.

FIG. 2A is cross-sectional view of a backlight as described herein that includes two light source boards and one patterned diffuser.

FIG. 2B is cross-sectional view of a backlight as described herein that includes one light source board and two patterned diffusers.

FIGS. 3A-3C are various views of an exemplary backlight including patterned reflectors;

FIG. 4 is a cross-sectional view of an exemplary liquid crystal display (LCD) including the exemplary backlight of FIGS. 3A-3C;

FIG. 5 is a cross-sectional view of an exemplary backlight including patterned reflectors;

FIG. 6 is a cross-sectional view of an exemplary backlight including patterned reflectors and a diffusive layer;

FIG. 7 is a cross-sectional view of another exemplary backlight including patterned reflectors;

FIG. 8 is a cross-sectional view of another exemplary backlight including patterned reflectors and a diffusive layer;

FIG. 9 is a cross-sectional view of another exemplary backlight including patterned reflectors and a diffusive layer;

FIG. 10 is a cross-sectional view of another exemplary backlight including patterned reflectors and a diffusive layer;

FIG. 11 is a cross-sectional view of an exemplary backlight including patterned reflectors and an optical component;

FIGS. 12A and 12B are various views of another exemplary backlight including patterned reflectors;

FIGS. 13A and 13B are various views of another exemplary backlight including patterned reflectors;

FIG. 14 is a cross-sectional view of another exemplary backlight including an encapsulation layer;

FIG. 15 is a cross-sectional view of another exemplary backlight including an encapsulation layer;

FIG. 16 is a cross-sectional view of an exemplary backlight including an encapsulation layer bonded to a first layer of an optical film stack;

FIG. 17 is a cross-sectional view of an exemplary backlight including a light guide plate bonded to an encapsulation layer;

FIG. 18 is a cross-sectional view of an exemplary backlight including a diffusive layer bonded to an encapsulation layer;

FIG. 19 is a cross-sectional view of an exemplary backlight including a diffusive layer bonded to a first layer of an optical film stack;

FIG. 20 is a cross-sectional view of an exemplary backlight including a light guide plate bonded to an encapsulation layer and a further encapsulation layer bonded to a first layer of an optical film stack;

FIG. 21 is a cross-sectional view of an exemplary backlight including a light guide plate bonded to a first layer of an optical film stack and a further encapsulation layer bonded to an encapsulation layer; and

FIG. 22 is a graph of pattern shift versus tile size for three different combinations of patterned diffuser body and substrate.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein - for example up, down, right, left, front, back, top, bottom, vertical, horizontal - are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

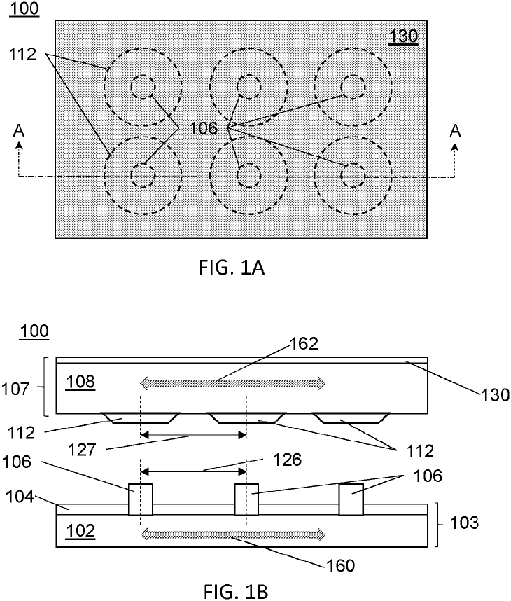

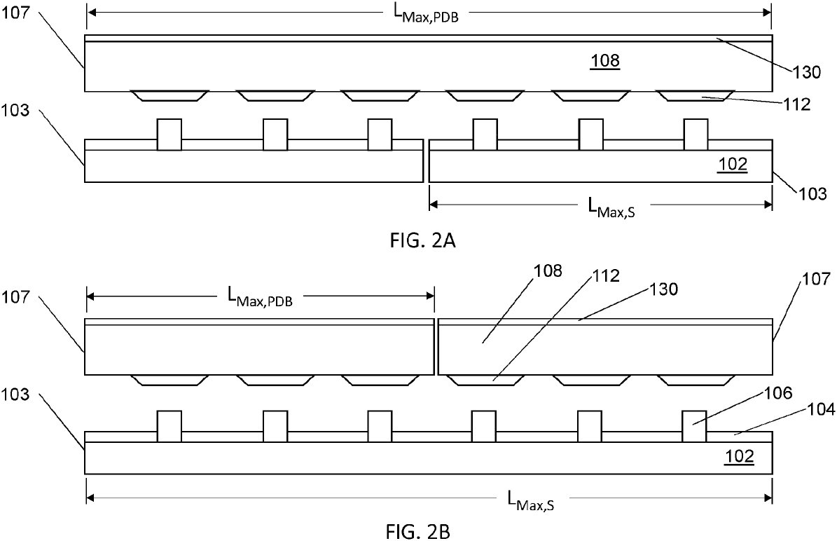

In some embodiments, a backlight 100 having improved light distribution over a large area is provided. As shown in FIGS. 1A through 2B, the backlight 100 includes a plurality of light sources 106 coupled to a substrate 102, and a patterned diffuser 107 over the plurality of light sources 106. The patterned diffuser 107 includes a plurality of patterned reflectors 112 coupled to a patterned diffuser body 108, where each patterned reflector 112 is positioned to align with a corresponding light source 108. The backlight 100 can have a longitudinal direction (i.e., a direction parallel to the longest in-plane distance from one edge of the backlight 100 to another). For example, cut line A-A in FIG. 1A is taken along a longitudinal direction.

As used herein the patterned diffuser body 108 is the body to which the patterned reflectors 112 are coupled that dictates the relative position of the patterned reflectors 112 in the longitudinal (and lateral directions). In particular, thermal expansion or contraction of the patterned diffuser body 108 will change the relative spacing of the patterned reflectors 112. In some embodiments, the patterned diffuser body 108 can be a light guide plate, a diffuser, or other component meeting the optical and physical properties described herein. In some embodiments, the patterned diffuser plate 108 can comprise or be glass, glass-ceramic, polymer, ceramic, or another material substrate. In some embodiments, the patterned diffuser body 108 is a light guide plate. As used herein, when the term light guide plate 108 is used, it should be understood that another patterned diffuser body 108 could be used in place of the light guide body 108.

In a similar manner, the substrate 102 of the light source board 103 dictates the relative position of the light sources 106 in the longitudinal (and lateral directions). In particular, thermal expansion or contraction of the patterned diffuser body 108 will change the relative spacing of the light sources 106.

As shown in FIGS. 2A-2B, the substrate 102 and the patterned diffuser body 108 have a maximum longitudinal substrate dimension (L_{Max},S) and a maximum longitudinal patterned diffuser body dimension (L_{Max},_{PDB}), respectively, in the longitudinal direction. In some embodiments, as shown in FIG. 2A, the maximum longitudinal patterned diffuser body dimension (L_{Max},_{PDB}) is greater than the maximum longitudinal substrate dimension (L_{Max},ₛ). Is other embodiments, as shown in FIG. 2B, the maximum longitudinal substrate dimension (L_{Max},S) is greater than the maximum longitudinal patterned diffuser body dimension (L_{Max},_{PDB}). Alternately, as shown in FIG. 1B, the maximum longitudinal substrate dimension (L_{Max},S) and the maximum longitudinal patterned diffuser body dimension (L_{M}_{3X},_{PDB}) are the same in some embodiments.

As shown in FIG. 1B, as the backlight 100 is heated, the substrate 102 and the patterned diffuser body (e.g., light guide plate) 108 will undergo longitudinal expansion 160 and 162, respectively. The relative differences between the amounts of longitudinal expansion 160, 162 can cause the corresponding light source 106 and patterned reflector 112 to fall out of alignment, which will produce defects in the backlight 100.

In some embodiments, the thermal alignment tolerance in the longitudinal direction at a backlight operating temperature is 500 microns or less. As used herein, the thermal alignment tolerance at 60° C. is the absolute value of [the smaller of L_{Max},_{S} and L_{Max},_{PDB]} x [60 - 23.5° C.] x [substrate coefficient of thermal expansion (CTEₛ) — patterned diffuser body coefficient of thermal expansion (CTE_{PDB})]. In this equation, room temperature is set at 23.5° C. In this way, when the backlight 100 is at 60° C., the maximum shift (misalignment) of an individual patterned reflector 112 relative to a corresponding light source 106 will be less than 500 microns. The thermal alignment tolerance can be calculated using values other than 60° C. Examples include, but are not limited to, 0° C., 80° C., 100° C., and 120° C.

A key attribute for alignment between patterned diffuser 107 and the light source board 103 is coefficient of thermal expansion (CTE) of the patterned diffuser body 108 and the substrate 102, respectively. Although to achieve light uniformity, there are multiple optical films and patterns of patterned reflectors, the CTE of patterned diffuser 107 is dominated by the patterned diffuser body (e.g., light guide plate) 108 since the volume fraction of those optical components are negligible. In the same manner, the substrate 102 for the light source board 103 has a large volume fraction that dominates the alignment capability of the light sources 106.

As described in Table 1, the CTE of some material candidates for the substrate 102 and the patterned diffuser body 108 include Eagle XG Glass (EXG available from Corning), soda-lime glass (SLG), and FR-4 (a polymer-based printed circuit board). Thus, using EXG as the substrate 102 and the patterned diffuser body 108 would result in the lowest pattern shift, which enables larger tiling size of the backlight 100 for a full size of the display (e.g., a large screen television). Since there exists size effect in terms of the pattern shift, there is restriction of the tiling size. Thus, using EXG as both the patterned diffuser body 108 and the substrate 102 can achieve the large tiling size for the backlight 100 with excellent light performance, including many local dimming zones.

| Materials | CTE (ppm/^{◦}C) |
|---|---|
| EXG | 3.17 |
| SLG | 9.5 |
| FR-4 | 12 ∼ 13 |

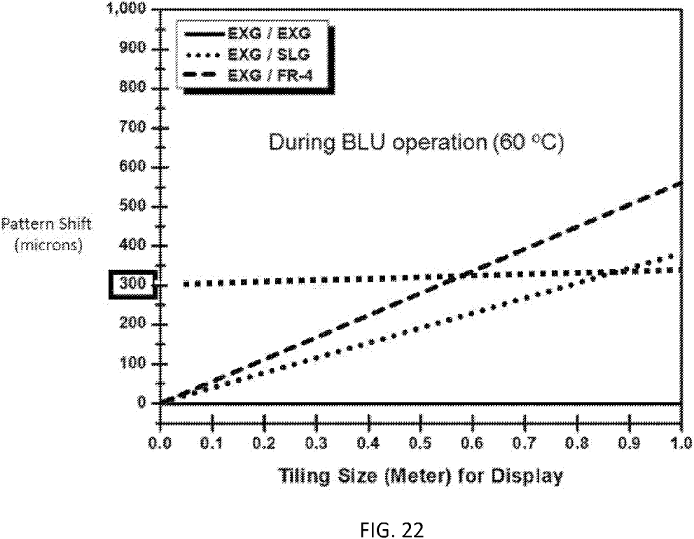

FIG. 22 shows a graph of pattern shift (i.e., thermal alignment tolerance) versus tile size with a pattern shift of less than 300 microns at 60° C. As can be seen, the EXG/FR-4 combination allows for a maximum tile size of between 0.5-0.6 meters, the EXG/SLG combination allows for a maximum tile size of approximately 0.8 meters, while the combination of EXG/EXG can be infinite in size theoretically.

In some embodiments, the difference between the substrate coefficient of thermal expansion (CTEₛ) and the patterned diffuser body coefficient of thermal expansion (CTE_{PDB})(ΔCTE) is 7.0 or less. In some embodiments, ΔCTL is 6.5 or less, or 6.0 or less, or 5.5 or less, or 5.0 or less, or 4.5 or less, or 4.0 or less, or 3.5 or less, or 3 or less, or 2.5 or less, or 2.0 or less.

In some embodiments, the thermal alignment tolerance in the longitudinal direction at the backlight operating temperature is 400 microns or less. In some embodiments, the thermal alignment tolerance in the longitudinal direction at the backlight operating temperature is 300 microns or less, or 250 microns or less, or 200 microns or less, or 150 microns or less, or 100 microns.

In some embodiments, at least one of L_{Max},_{S} and L_{Max},_{PDB} is at least 0.50 meters. In some embodiments, at least one of L_{Max},_{S} and L_{Max},_{PDB} is at least 0.75 meters, or at least 1.00 meters, or at least 1.25 meters, or at least 1.50 meters, or at least 1.75 meters, or at least 2.00 meters.

In some embodiments, the thermal alignment tolerance in the longitudinal direction at the backlight operating temperature is 400 microns or less and at least one of L_{Max},_{S} and L_{Max},_{PDB} is at least 0.50 meters, or at least 0.75 meters, or at least 1.00 meters, or at least 1.25 meters, or at least 1.50 meters, or at least 1.75 meters, or at least 2.00 meters.

In some embodiments, the thermal alignment tolerance in the longitudinal direction at the backlight operating temperature is 300 microns or less and at least one of L_{Max},_{S} and L_{Max},_{PDB} is at least 0.50 meters, or at least 0.75 meters, or at least 1.00 meters, or at least 1.25 meters, or at least 1.50 meters, or at least 1.75 meters, or at least 2.00 meters.

In some embodiments, as shown in FIG. 2A, the backlight 100 comprises at least two light source boards 103 in the longitudinal direction. In some embodiments, as shown in FIG. 2B, the backlight 100 comprises at least two patterned diffusers 107 in the longitudinal direction.

In some embodiments, the backlight 100 is formed from one light source board 103 and one patterned diffuser 107 in the longitudinal direction and L_{Max},_{S} = L_{Max},_{PDB}, and both L_{Max},_{S} and L_{Max},_{PDB} are greater than 0.50 meters. In some embodiments, the backlight 100 is formed from one light source boards 103 and one patterned diffuser 107 in the longitudinal direction and L_{Max},_{S} = L_{Max},_{PDB}, and both L_{Max},_{S} and L_{Max},_{PDB} are greater than 0.75 meters, or greater than 1.00 meter, or greater than 1.25 meters, or greater than 1.50 meters, or greater than 1.75 meters, or greater than 2.00 meters.

In some embodiments, the substrate 102 and the patterned diffuser body 108 are both formed of a glass (e.g., the same or a different glass). In some embodiments, the substrate 102 and the patterned diffuser body 108 are both formed of a plastic (e.g., the same or a different plastic). In some embodiments, the substrate 102 and the patterned diffuser body 108 are both formed of the same material.

In some embodiments, as shown in FIG. 1B, the pitch 126 of the light sources 106 can be the same as the pitch 127 of the patterned reflectors 112.

In some embodiments, the backlight 100 includes a first reflective layer 104 on the substrate 102.

In some embodiments, the plurality of patterned reflectors 112 are on a first surface of the patterned diffuser body 108. In some embodiments, the backlight 100 includes a diffusive layer 130 on a second surface of the patterned diffuser body 108 opposite to the first surface. In some such embodiments, as shown in FIG. 6, the first surface faces the substrate. In other such embodiments, as shown in FIG. 8, the second surface faces the substrate.

In some embodiments, as shown in FIG. 6, the backlight 100 includes a first layer 146 of an optical film stack over the light guide plate 108 and the diffusive layer 130 is bonded to the first layer 146 of the optical film stack.

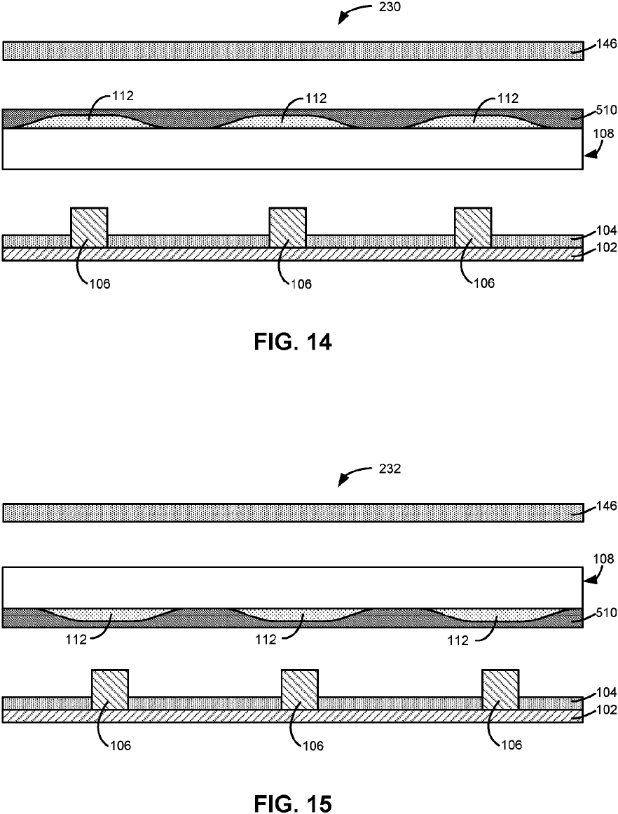

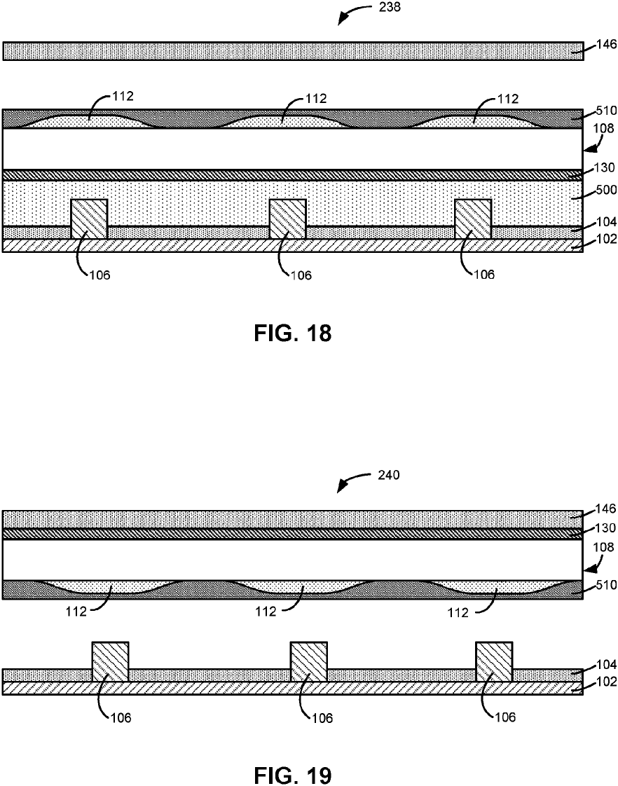

In some embodiments, as shown in FIGS. 17 and 18, the backlight 100 includes at least one encapsulation layer encapsulating the plurality of light sources. In some embodiments, as shown in FIGS. 14 and 15, the backlight 100 includes an encapsulation layer encapsulating the plurality of patterned reflectors.

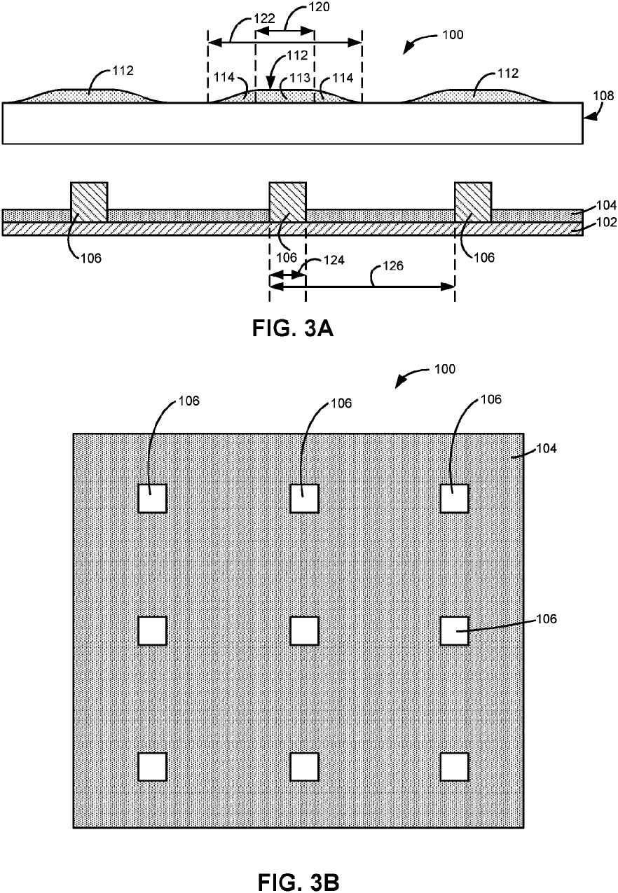

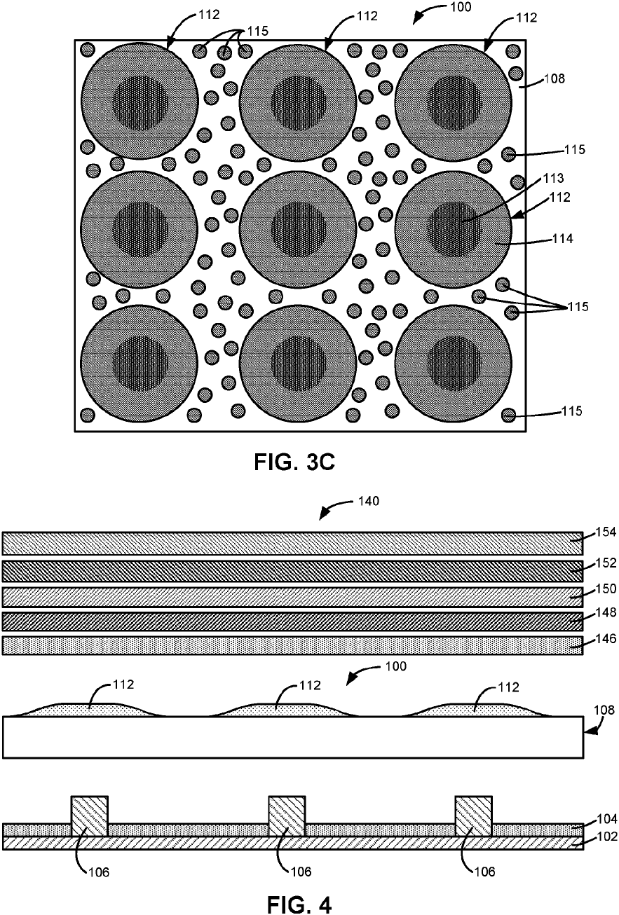

Additional features and details of the configurations of the backlight 100 follow. Referring now to FIGS. 1A-3C, various views of an exemplary backlight 100 are depicted. FIG. 3A is a cross-sectional view of backlight 100. Backlight 100 may include a substrate 102, a reflective layer 104, a plurality of light sources 106, a light guide plate 108, and a plurality of patterned reflectors 112. The plurality of light sources 106 are arranged on substrate 102 and are in electrical communication with the substrate 102. The reflective layer 104 is on the substrate 102 and surrounds each light source 106. In certain exemplary embodiments, the substrate 102 may be reflective such that the reflective layer 104 may be excluded. The light guide plate 108 is over the plurality of light sources 106 and optically coupled to each light source 106. In certain exemplary embodiments, an optical adhesive (not shown) may be used to couple the plurality of light sources 106 to the light guide plate 108. The optical adhesive (e.g., phenyl silicone) may have a refractive index greater than or equal to a refractive index of the light guide plate 108. The plurality of patterned reflectors 112 are arranged on the upper surface of the light guide plate 108. Each patterned reflector 112 is aligned with a corresponding light source 106.

Each patterned reflector 112 includes a thickness profile including a substantially flat section as indicated at 113 and a curved section as indicated at 114 extending from and surrounding the substantially flat section 113. The substantially flat section 113 may have a rough surface profile. In certain exemplary embodiments, the substantially flat section 113 varies in thickness by no more than plus or minus 20 percent of an average thickness of the substantially flat section. In this embodiment, the average thickness (measured in the direction orthogonal to the light guide plate 108) is defined as the maximum thickness (Tₘₐₓ) of the substantially flat section plus the minimum thickness (Tₘᵢₙ) of the substantially flat section divided by two (i.e., (Tₘₐₓ+Tₘᵢₙ)/2). For example, for an average thickness of the substantially flat section 113 of about 100 micrometers, the maximum thickness of the substantially flat section would be equal to or less than about 120 micrometers and the minimum thickness of the substantially flat section would be equal to or greater than about 80 micrometers. In other embodiments, the substantially flat section 113 varies in thickness by no more than plus or minus 15 percent of an average thickness of the substantially flat section. For example, for an average thickness of the substantially flat section 113 of about 80 micrometers, the maximum thickness of the substantially flat section would be equal to or less than about 92 micrometers and the minimum thickness of the substantially flat section would be equal to or greater than about 68 micrometers. In yet other embodiments, the substantially flat section 113 varies in thickness by no more than plus or minus 10 percent of an average thickness of the substantially flat section. For for an average thickness of the substantially flat section 113 of about 50 micrometers, the maximum thickness of the substantially flat section would be equal to or less than about 55 micrometers and the minimum thickness of the substantially flat section would be equal to or greater than about 45 micrometers. The curved section 114 may be defined as the absolute ratio of the change in thickness over the change in the distance from the center of the patterned reflector 112. The slope of the curved section 114 may decrease with the distance from the center of the patterned reflector 112. In certain exemplary embodiments, the slope is highest near the substantially flat section 113, rapidly decreases with the distance from the center of the patterned reflector 112, and then slowly decreases with further distance from the center of the patterned reflector

The size L0 (i.e., width or diameter) of each substantially flat section 113 as indicated at 120 (in a plane parallel to the longitudinal direction) may be greater than the size (i.e., width or diameter) of each corresponding light source 106 as indicated at 124 (in a plane parallel to the longitudinal direction). It should be noted that references to parallel to the longitudinal direction also parallel to a surface of the substrate 102. The size 120 of each substantially flat section 113 may be less than the size 124 of each corresponding light source 106 times a predetermined value. In certain exemplary embodiments, when the size 124 of the each light source 106 is greater than or equal to about 0.5 millimeters, the predetermined value may be about two or about three, such that the size of each substantially flat section 113 is less than three times the size of each light source 106. When the size 124 of each light source 106 is less than 0.5 millimeters, the predetermined value may be determined by the alignment capability between the light sources 106 and the patterned reflectors 112, such that the size of each substantially flat section 113 of each of patterned reflector 112 is within a range between about 100 micrometers and about 300 micrometers greater than the size of each light source 106. Each substantially flat section 113 is large enough such that each patterned reflector 112 can be aligned to the corresponding light source 106 and small enough to achieve suitable luminance uniformity and color uniformity.

The size L1 (i.e., width or diameter) of each patterned reflector 112 is indicated at 122 (in a plane parallel to the longitudinal direction) and the pitch P between adjacent light sources 106 is indicated at 126. While the pitch is illustrated along one direction in FIG. 3A, it is noted that the pitch may be different in a direction orthogonal to the direction illustrated. The pitch may, for example, be about 90, 45, 30, 10, 5, 2, 1, or 0.5 millimeters, larger than about 90 millimeters, or smaller than about 0.5 millimeters. In certain exemplary embodiments, the ratio L1/P of the size 122 of each patterned reflector 112 over the pitch 126 is within a range between about 0.45 and 1.0. The ratio may vary with the pitch 126 of the light sources 106 and the distance between the emission surface of each light source and the corresponding patterned reflector 112. For example, for a pitch 126 equal to about 5 millimeters and a distance between the emission surface of each light source and the corresponding patterned reflector equal to about 0.2 millimeters, the ratio may equal about 0.50, 0.60, 0.70, 0.80, 0.90, or 1.0.

Each patterned reflector 112 reflects at least a portion of the light emitted from the corresponding light source 106 into the light guide plate 108. Each patterned reflector 112 has a specular reflectance and a diffuse reflectance. The specularly reflected light exits from the bottom surface of the light guide plate 108. While this light travels laterally primarily due to the reflection between the reflective layer 104 and the light guide plate 108, or due to the reflection between the reflective layer 104 and the quantum dot film, diffuser sheet, or diffuser plate (shown below in FIG. 4), some loss of light may occur due to imperfect reflection from the reflective layer 104.

The diffusively reflected light has an angular distribution between 0° and 90° measured from the normal of the light guide plate 108. About 50 percent of the diffusively reflected light has an angle exceeding the critical angle (θ_{TIR}) of the total internal reflection. Thus, this light can travel laterally due to the total internal reflection without any loss, until the light is subsequently extracted out of the light guide plate 108 by patterned reflectors 112.

FIG. 3B is a top view of the plurality of light sources 106 and reflective layer 104 on substrate 102. Light sources 106 are arranged in a 2D array including a plurality of rows and a plurality of columns. While nine light sources 106 are illustrated in FIG. 3B in three rows and three columns, in other embodiments backlight 100 may include any suitable number of light sources 106 arranged in any suitable number of rows and any suitable number of columns. Light sources 106 may also be arranged in other periodic patterns, for example, a hexagonal or triangular lattice, or as quasi-periodic or non-strictly periodic patterns. For example, the spacing between light sources 106 may be smaller at the edges and/or corners of the backlight.

Substrate 102 (FIG. 3A) may be a printed circuit board (PCB), a glass or plastic substrate, or another suitable substrate for passing electrical signals to each light source 106 for individually controlling each light source. Substrate 102 may be a rigid substrate or a flexible substrate. For example, substrate 102 may include flat glass or curved glass. The curved glass, for example, may have a radius of curvature less than about 2000 millimeters, such as about 1500, 1000, 500, 200, or 100 millimeters. The reflective layer 104 may include, for metallic foils, such as silver, platinum, gold, copper, and the like; dielectric materials (e.g., polymers such as polytetrafluoroethylene (PTFE)); porous polymer materials, such as polyethylene terephthalate (PET), Poly(methyl methacrylate) (PMMA), polyethylene naphthalate (PEN), polyethersulfone (PES), etc.; multi-layer dielectric interference coatings, or reflective inks, including white inorganic particles such as titania, barium sulfate, etc., or other materials suitable for reflecting light and tuning the color of the reflected and transmitted light, such as colored pigments.

Each of the plurality of light sources 106 may, for example, be an LED (e.g., size larger than about 0.5 millimeters), a mini-LED (e.g., size between about 0.1 millimeters and about 0.5 millimeters), a micro-LED (e.g., size smaller than about 0.1 millimeter), an organic LED (OLED), or another suitable light source having a wavelength ranging from about 400 nanometers to about 750 nanometers. In other embodiments, each of the plurality of light sources may have a wavelength shorter than 400 nanometers and/or longer than 750 nanometers. The light from each light source 106 is optically coupled to the light guide plate 108. As used herein, the term “optically coupled” is intended to denote that a light source is positioned at a surface of the light guide plate 108 and is in an optical communication with the light guide plate 108 directly or through an optically clear adhesive, so as to introduce light into the light guide plate that at least partially propagates due to total internal reflection. The light from each light source 106 is optically coupled to the light guide plate 108 such that a first portion of the light travels laterally in the light guide plate 108 due to the total internal reflection and is extracted out of the light guide plate by the patterned reflectors 112, and a second portion of the light travels laterally between the reflective layer 104 and the patterned reflectors 112 due to multiple reflections at the reflective surfaces of the reflective layer 104 and the patterned reflectors 112 or between an optical film stack (shown in FIG. 4) and the reflective layer 104.

According to various embodiments, the light guide plate 108 may include any suitable transparent material used for lighting and display applications. As used herein, the term “transparent” is intended to denote that the light guide plate has an optical transmission of greater than about 70 percent over a length of 500 millimeters in the visible region of the spectrum (about 420-750 nanometers). In certain embodiments, an exemplary transparent material may have an optical transmittance of greater than about 50 percent in the ultraviolet (UV) region (about 100-400 nanometers) over a length of 500 millimeters. According to various embodiments, the light guide plate may include an optical transmittance of at least 95 percent over a path length of 50 millimeters for wavelengths ranging from about 450 nanometers to about 650 nanometers.

The optical properties of the light guide plate may be affected by the refractive index of the transparent material. According to various embodiments, the light guide plate 108 may have a refractive index ranging from about 1.3 to about 1.8. In other embodiments, the light guide plate 108 may have a relatively low level of light attenuation (e.g., due to absorption and/or scattering). The light attenuation (α) of the light guide plate 108 may, for example, be less than about 5 decibels per meter for wavelengths ranging from about 420-750 nanometers. The light guide plate 108 may include polymeric materials, such as plastics (e.g., polymethyl methacrylate (PMMA), methylmethacrylate styrene (MS), polydimethylsiloxane (PDMS)), polycarbonate (PC), or other similar materials. The light guide plate 108 may also include a glass material, such as aluminosilicate, alkali-aluminosilicate, borosilicate, alkali-borosilicate, aluminoborosilicate, alkali-aluminoborosilicate, soda lime, or other suitable glasses. Nonlimiting examples of commercially available glasses suitable for use as a glass light guide plate 108 include EAGLE XG®, Lotus™, Willow®, Iris™, and Gorilla® glasses from Corning Incorporated. In examples where substrate 102 includes curved glass, light guide plate 108 may also include curved glass to form a curved backlight.

FIG. 3C is a top view of the plurality of patterned reflectors 112 on the light guide plate 108. Each patterned reflector 112 may include a substantially flat section 113 and a curved section 114. In addition, each patterned reflector 112 may include individual dots 115 on the light guide plate 108. The substantially flat section 113 may be more reflective than the curved section 114, and the curved section 114 may be more transmissive than the substantially flat section 113. Each curved section 114 may have properties that change in a continuous and smooth way with distance from the substantially flat section 113. While in the embodiment illustrated in FIG. 3C, each patterned reflector 112 is circular in shape, in other embodiments each patterned reflector 112 may have another suitable shape (e.g., rectangular, hexagonal, etc.). With the patterned reflectors 112 fabricated directly on the upper surface of the light guide plate 108, the patterned reflectors 112 increase the ability of hiding the light sources 106. Fabricating patterned reflectors 112 directly on the upper surface of the light guide plate 108 also saves space.

In certain exemplary embodiments, each patterned reflector 112 is a diffuse reflector, such that each patterned reflector 112 further enhances the performance of the backlight 100 by scattering some light rays at high enough angles such that they can propagate in the light guide plate 108 by total internal reflection. Such rays will then not experience multiple bounces between the patterned reflectors 112 and the reflective layer 104 or between an optical film stack and the reflective layer 104 and therefore avoid loss of optical power, thereby increasing the backlight efficiency. In certain exemplary embodiments, each patterned reflector 112 is a specular reflector. In other embodiments, some areas of each patterned reflector 112 have a more diffuse character of reflectivity and some areas have a more specular character of reflectivity.

Each patterned reflector 112 may be formed, for example, by printing (e.g., inkjet printing, screen printing, microprinting, etc.) a pattern with white ink, black ink, metallic ink, or other suitable ink. Each patterned reflector 112 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

In certain exemplary embodiments where white light sources 106 are used, the presence of different reflective and absorptive materials in variable density in the patterned reflectors 112 may be beneficial for minimizing the color shift across each of the dimming zones of the backlight. Multiple bounces of light rays between the patterned reflectors and the reflective layer 104 (FIG. 3A) may cause more loss of light in the red part of the spectrum than in the blue, or vice versa. In this case, engineering the reflection to be color neutral, for example by using slightly colored reflective/absorptive materials, or materials with the opposite sign of dispersion (in this case, dispersion means spectral dependence of the reflection and/or absorption) may minimize the color shift.

FIG. 4 is a cross-sectional view of an exemplary liquid crystal display (LCD) 140. LCD 140 includes a backlight 100 including patterned reflectors 112 as previously described and illustrated with reference to FIGS. 1A-3C. In addition, LCD 140 includes optionally a diffuser plate 146 over backlight 100, optionally a quantum dot film 148 over the diffuser plate 146, optionally a prismatic film 150 over the quantum dot film 148, optionally a reflective polarizer 152 over the prismatic film 150, and a display panel 154 over the reflective polarizer 152.

To maintain the alignment between the light sources 106 and the patterned reflectors 112 on the light guide plate 108 for the proper functioning of the backlight 100, it is advantageous if the light guide plate 108 and the substrate 102 are made of the same or similar type of material so that both the patterned reflectors 112 on the light guide plate 108 and the light sources 106 on the substrate 102 are registered well to each other over a large range of operating temperatures. In certain exemplary embodiments, the light guide plate 108 and the substrate 102 are made of the same plastic material. In other embodiments, the light guide plate 108 and the substrate 102 are made of the same type of glass.

An alternative solution to keep the light guide plate 108 and light sources 106 on the substrate 102 in alignment is to use a highly flexible substrate. The highly flexible substrate may be made of a polyimide or other high temperature resistant polymer film to allow component soldering. The highly flexible substrate may also be made of materials such as FR4 or fiberglass, but of a significantly lower thickness than usual. In certain exemplary embodiments, an FR4 material of 0.4 millimeters thickness may be used for substrate 102, which may be sufficiently flexible to absorb the dimensional changes resulting from changing operating temperatures.

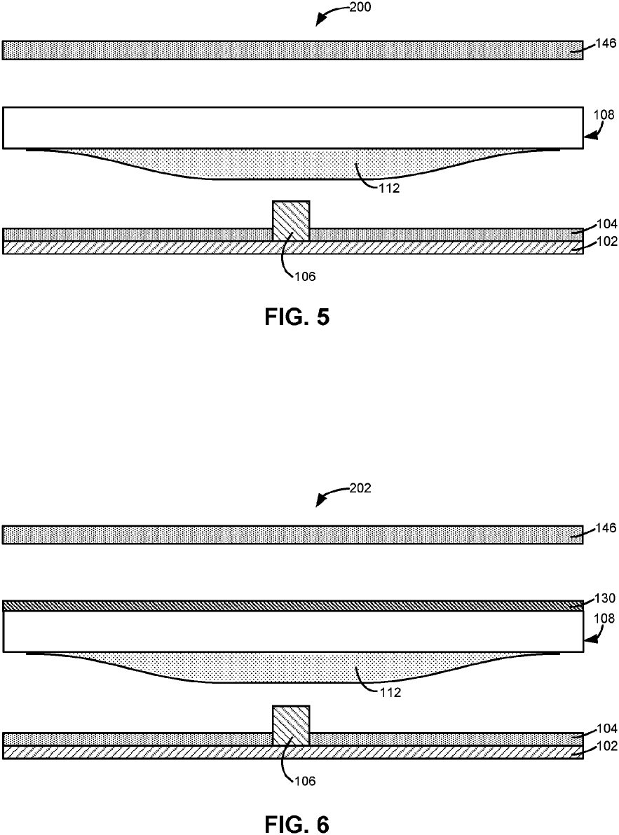

FIG. 5 is a simplified cross-sectional view of an exemplary backlight 200. Backlight 200 is similar to backlight 100 previously described and illustrated with reference to FIGS. 1A-3C except that in backlight 200, each patterned reflector 112 faces the corresponding light source 106. While FIG. 5 illustrates a single light source 106 and a corresponding single patterned reflector 112 for simplicity, it will be understood that backlight 200 may include any suitable number of light sources 106 and corresponding patterned reflectors 112. Backlight 200 may include a substrate 102, a reflective layer 104, a plurality of light sources 106, a light guide plate 108, and a plurality of patterned reflectors 112 as previously described and illustrated with reference to FIGS. 1A-3C. Backlight 200 also includes the first layer 146 of an optical film stack (not shown) over the light guide plate 108. The first layer 146 of the optical film stack may include a diffuser plate, a quantum dot film, a prismatic film, or another suitable plate or film. In this embodiment, each patterned reflector 112 is on a first surface of the light guide plate 108, where the first surface of the light guide plate faces the plurality of light sources 106.

FIG. 6 is a simplified cross-sectional view of an exemplary backlight 202. Backlight 202 is similar to backlight 200 previously described and illustrated with reference to FIG. 5. Backlight 202 may include a substrate 102, a reflective layer 104, a plurality of light sources 106, a light guide plate 108, and a plurality of patterned reflectors 112 as previously described and illustrated with reference to FIGS. 1A-3C. In addition, backlight 202 includes a diffusive layer 130. Backlight 202 also includes the first layer 146 of an optical film stack (not shown) over the diffusive layer 130.

Diffusive layer 130 is on a second surface of the light guide plate 108 opposite to the first surface of the light guide plate. Diffusive layer 130 faces away from the plurality of light sources 106. Diffusive layer 130 improves the lateral spreading of the light emitted from the light sources 106, thereby improving light uniformity. The diffusive layer 130 may have specular and diffuse reflectance and specular and diffuse transmittance. The specular reflectance or transmittance is the percent of reflected or transmitted light along the specular direction with 0 or 8 degrees depending on the measurement setup, while the diffuse reflectance or transmittance is the percent of reflected or transmitted light excluding the specular reflectance or transmittance. The diffusive layer 130 may have a haze and a transmittance. The diffusive layer 130 may have a haze, for example, of about 10, 20, 30, 40, 50, 60, 70, 80, 90, 95, or 99 percent or higher, and a transmittance of about 20, 30, 40, 50, 60, 70, 80, 90, or 95 percent or higher. In certain exemplary embodiments, the diffusive layer 130 has a haze of about 70 percent and a total transmittance of about 90 percent. In other embodiments, the diffusive layer 130 has a haze of about 88 percent and a total transmittance of about 96 percent. Haze is defined as the percent of transmitted light that is scattered so that its direction deviates more than 2.5 degrees from the direction of the incident beam, and transmittance is defined as the percent of transmitted light, per American Society for Testing and Materials (ASTM) D1003 “Standard Test Method for Haze and Luminous Transmittance of Transparent Plastics.” Haze and transmittance can be measured by various haze meters.

Diffusive layer 130 diffuses rays from the light source 106. As a result, the patterned reflector 112 of backlight 202 may be thinner than a patterned reflector of a backlight not including diffusive layer 130 while still effectively hiding the light source 106. Diffusive layer 130 also diffuses rays that otherwise would undergo total internal reflection. In addition, diffusive layer 130 diffuses any rays that are reflected back by the quantum dot film, diffuser sheet, or diffuser plate 146. Thus, the diffusive layer 130 increases the light recycling effect caused by the quantum dot film, diffuser sheet, or diffuser plate 146 and any prismatic films (not shown) over the diffuser plate or diffuser sheet, such as one or two brightness enhancement films.

In certain exemplary embodiments, diffusive layer 130 includes a uniform or continuous layer of scattering particles. Diffusive layer 130 is considered to include a uniform layer of scattering particles where the distance between neighboring scattering particles is less than one fifth the size of the light source. Regardless of the location of diffusive layer 130 relative to the light source, diffusive layer 130 exhibits a similar diffusive property. The scattering particles may, for example, be within a clear or white ink that includes micro-sized or nano-sized scattering particles, such as alumina particles, TiO₂ particles, PMMA particles, or other suitable particles. The particle size may vary, for example, within a range from about 0.1 micrometers and about 10.0 micrometers. In other embodiments, diffusive layer 130 may include an anti-glare pattern. The anti-glare pattern may be formed of a layer of polymer beads or may be etched. In this embodiment, diffusive layer 130 may have a thickness, for example, of about 1, 3, 7, 14, 21, 28, or 50 micrometers, or another suitable thickness.

In certain exemplary embodiments, diffusive layer 130 may include a pattern that may be applied to the light guide plate 108 via screen printing. The diffusive layer 130 may be screen printed on a primer layer (e.g., an adhesive layer) applied to the light guide plate 108. In other embodiments, diffusive layer 130 may be applied to the light guide plate 108 by laminating the diffusive layer to the light guide plate via an adhesive layer. In yet other embodiments, diffusive layer 130 may be applied to the light guide plate 108 by embossing (e.g., thermal or mechanical embossing) the diffusive layer into the light guide plate, stamping (e.g., roller stamping) the diffusive layer into the light guide plate, or injection molding the diffusive layer. In yet other embodiments, diffusive layer 130 may be applied to the light guide plate 108 by etching (e.g., chemical etching) the light guide plate. In some embodiments, diffusive layer 130 may be applied to the light guide plate 108 with a laser (e.g., laser damaging).

In yet other embodiments, diffusive layer 130 may include a plurality of hollow beads. The hollow beads may be plastic hollow beads or glass hollow beads. The hollow beads, for may be glass bubbles available from 3M Company under the trade designations “3M GLASS BUBBLES iM30K”. These glass bubbles have glass compositions including SiO₂ in a range from about 70 to about 80 percent by weight, alkaline earth metal oxide in a range from about 8 to about 15 percent by weight, and alkali metal oxide in a range from about 3 to about 8 percent by weight, and B₂O₃ in a range from about 2 to about 6 percent by weight, where each percent by weight is based on the total weight of the glass bubbles. In certain exemplary embodiments, the size (i.e., diameter) of the hollow beads may vary, for example, from about 8.6 micrometers to about 23.6 micrometers, with a median size of about 15.3 micrometers. In another embodiment, the size of the hollow beads may vary, for example, from about 30 micrometers to about 115 micrometers, with the median size of about 65 micrometers. In yet other embodiments, diffusive layer 130 may include a plurality of nano-sized color conversion particles such as red and/or green quantum dots. In yet other embodiments, diffusive layer 130 may include a plurality of hollow beads, nano-sized scattering particles, and nano-sized color conversion particles such as red and/or green quantum dots.

The hollow beads may first be uniformly mixed with a solvent (e.g., Methyl Ethyl Ketone (MEK)), subsequently mixed with any suitable binder (e.g., Methyl methacrylate and silica), and then fixed by thermal or ultraviolet (UV) curing if necessary to form a paste. The paste may then be deposited onto the surface of the light guide plate 108 through slot coating, screen printing, or any other suitable means to form the diffusive layer 130. In this embodiment, the diffusive layer 130 may have a thickness, for example, between about 10 micrometers and about 100 micrometers. In another the diffusive layer 130 may have a thickness between about 100 micrometers and about 300 micrometers. Multiple coatings may be used to form a thick diffusive layer if needed. In each example, the haze of the diffusive layer 130 may be more than 99 percent as measured with a haze meter such as BYK-Gardner’s Haze-Gard. Two advantages of using hollow beads within diffusive layer 130 includes 1) reducing the weight of the diffusive layer 130; and 2) achieving a desired haze level at a small thickness.

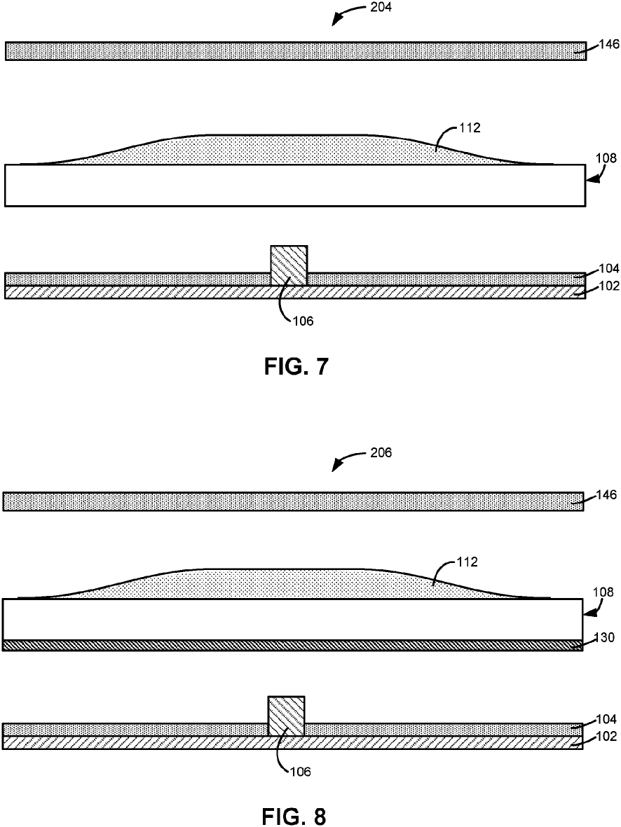

FIG. 7 is a simplified cross-sectional view of another exemplary backlight 204. Backlight 204 is similar to backlight 100 previously described and illustrated with reference to FIGS. 1A-3C. For backlight 204, each patterned reflector 112 faces away from the corresponding light source 106. Backlight 204 may include a substrate 102, a reflective layer 104, a plurality of light sources 106, a light guide plate 108, and a plurality of patterned reflectors 112 as previously described and illustrated with reference to FIGS. 1A-3C. Backlight 204 also includes the first layer 146 of an optical film stack (not shown) over the light guide plate 108. Each patterned reflector 112 is on a first surface of the light guide plate 108, where the first surface of the light guide plate faces away from the plurality of light sources 106.

FIG. 8 is a simplified cross-sectional view of another exemplary backlight 206. Backlight 206 is similar to backlight 204 previously described and illustrated with reference to FIG. 7. Backlight 206 may include a substrate 102, a reflective layer 104, a plurality of light sources 106, a light guide plate 108, and a plurality of patterned reflectors 112 as previously described and illustrated with reference to FIGS. 1A-3C. In addition, backlight 202 includes a diffusive layer 130. Backlight 206 also includes the first layer 146 of an optical film stack (not shown) over the plurality of patterned reflectors 112.

Diffusive layer 130 is on a second surface of the light guide plate 108 opposite to the first surface of the light guide plate. In this embodiment, the diffusive layer 130 faces the plurality of light sources 106 and the plurality of patterned reflectors 112 face away from the plurality of light sources 106. Diffusive layer 130 may include any of the features of diffusive layer 130 previously described with reference to FIG. 6.

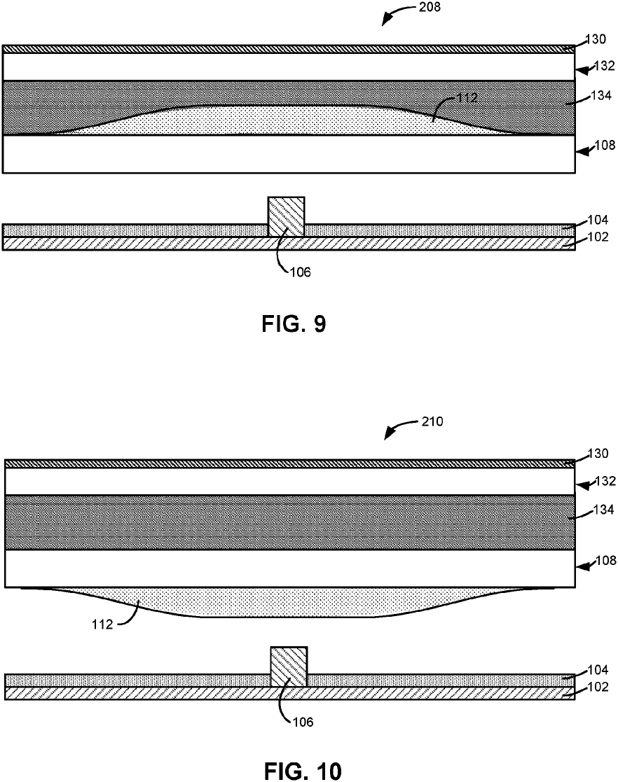

FIG. 9 is a simplified cross-sectional view of another exemplary backlight 208. Backlight 208 may include a substrate 102, a reflective layer 104, a plurality of light sources 106, a first light guide plate 108, and a plurality of patterned reflectors 112 as previously described and illustrated with reference to FIGS. 1A-3C. In addition, backlight 208 includes a diffusive layer 130, a second light guide plate 132, and an adhesive layer 134. Diffusive layer 130 is on a first surface of the second light guide plate 132. A second surface of the second light guide plate 132 opposite to the first surface is coupled to the plurality of patterned reflectors 112 and the first light guide plate 108 via the adhesive layer 134. In this embodiment, the plurality of patterned reflectors 112 face away from the plurality of light sources 106 and are embedded in the adhesive material 134.

Diffusive layer 130 may include any of the features of diffusive layer 130 previously described with reference to FIG. 6. Adhesive layer 134 may include an optically clear adhesive (e.g., phenyl silicone) or another suitable material to bond the second light guide plate 132 to the plurality of patterned reflectors 112 and the first light guide plate 108. In certain exemplary embodiments, second light guide plate 132 may include any of the features of light guide plate 108 previously described with reference to FIGS. 1A-3C. Using a separate second light guide plate 132 upon which the diffusive layer 130 is formed, which is then bonded to the first light guide plate 108 enables additional flexibility in fabricating the diffusive layer 130 and the plurality of patterned reflectors 112. In addition, using a separate second light guide plate 132 enables the separate examination of the diffusive layer 130 on the second light guide plate 132 and the plurality of patterned reflectors 112 on the first light guide plate 108 prior to assembling backlight 208.

FIG. 10 is a simplified cross-sectional view of another exemplary backlight 210. Backlight 210 may include a substrate 102, a reflective layer 104, a plurality of light sources 106, a first light guide plate 108, and a plurality of patterned reflectors 112 as previously described and illustrated with reference to FIGS. 1A-3C. In addition, backlight 202 includes a diffusive layer 130, a second light guide plate 132, and an adhesive layer 134 as previously described and illustrated with reference to FIG. 9. Diffusive layer 130 is on a first surface of the second light guide plate 132. A second surface of the second light guide plate 132 opposite to the first surface is coupled to the first light guide plate 108 via the adhesive layer 134. In this embodiment, the plurality of patterned reflectors 112 face the plurality of light sources 106. In other embodiments, the adhesive layer 134 may be excluded and the first light guide plate 108 may be separated from the second light guide plate 132 by an air gap.

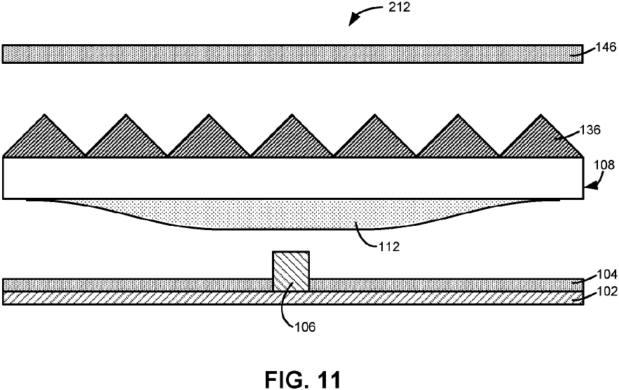

FIG. 11 is a simplified cross-sectional view of an exemplary backlight 212. Backlight 212 is similar to backlight 200 previously described and illustrated with reference to FIG. 5 except that backlight 212 includes an optical component 136. Backlight 212 may include a substrate 102, a reflective layer 104, a plurality of light sources 106, a light guide plate 108, and a plurality of patterned reflectors 112 as previously described and illustrated with reference to FIGS. 1A-3C. Backlight 212 also includes the first layer 146 of an optical film stack (not shown) over the optical component 136. Each patterned reflector 112 is on a first surface of the light guide plate 108, where the first surface of the light guide plate faces the plurality of light sources 106.

The optical component 136 is on a second surface of the light guide plate 108 opposite to the first surface, where the second surface of the light guide plate faces away from the plurality of light sources 106, such that the optical component 136 faces away from the plurality of light sources 106. The optical component 136 may include a quantum dot film, a prismatic or lenticular lens, or another suitable optical component. In the example of the prismatic or lenticular lens, the prismatic or lenticular lens may be linear or circular. The prismatic or lenticular lens may include nano-sized and/or micro-sized scattering particles as described above with reference to the diffusive layer 130. The micro-sized scattering particles can be hollow beads. The prismatic lens may have a rounded or sharp apex angle. In the example of the quantum dot film, by placing the quantum dot film directly on top of the light guide plate 108 the quantum dot film may be better protected from moisture and/or oxygen. The optical component 136 may be embedded in an adhesive material, and optionally be bonded to the adjacent optical component, for example, the first layer 146 of the optical film stack.

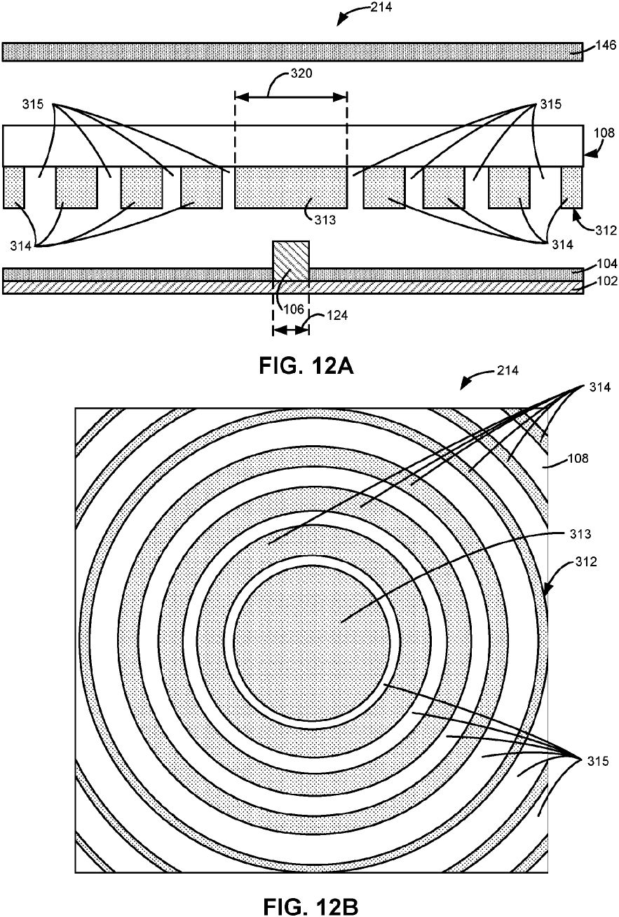

FIGS. 12A and 12B are various views of another exemplary backlight 214. FIG. 12A is a simplified cross-sectional view of backlight 214 and FIG. 12B is a bottom view of a patterned reflector 312 on a light guide plate 108. Backlight 214 is similar to backlight 200 previously described and illustrated with reference to FIG. 5, except that in backlight 214 patterned reflectors 312 are used in place of patterned reflectors 112. Backlight 214 may include a substrate 102, a reflective layer 104, a plurality of light sources 106, and a light guide plate 108 as previously described and illustrated with reference to FIGS. 3-3C. Backlight 214 also includes the first layer 146 of an optical film stack (not shown) over the light guide plate 108.

Each patterned reflector 312 is on a first surface of the light guide plate 108, where the first surface of the light guide plate faces the plurality of light sources 106. In other embodiments, the first surface of the light guide plate 108 may face away from the plurality of light sources 106 such that the patterned reflectors 312 face away from the plurality of light sources 106. Each patterned reflector 312 includes a first solid section 313, a plurality of second solid sections 314 surrounding the first solid section 313, and a plurality of open sections 315 interleaved with the plurality of second solid sections 314. As illustrated in FIG. 12B, each second solid section 314 and each open section 315 may be ring-like, such as circular, elliptical, or another suitable shape.

Patterned reflector 312 includes a pattern of reflective material to create a variable diffusive reflector. The reflective material may include, for example, metallic foils, such as silver, platinum, gold, copper, and the like; dielectric materials (e.g., polymers such as PTFE); porous polymer materials, such as PET, PMMA, PEN, PES, etc., multi-layer dielectric interference coatings, or reflective inks, including white inorganic particles such as titania, barium sulfate, etc., or other materials suitable for reflecting light.

An area ratio A(r) of each second solid section 314 may equal As(r) / (As(r) + Ao(r)), where r is the distance from the center of the corresponding patterned reflector 312, As(r) is the area of the corresponding second section 314, and Ao(r) is the area of the corresponding open section 315. The area ratio A(r) of each second solid section 314 decreases with the distance r, and a rate of the decrease decreases with the distance r.

The size L0 (i.e., width or diameter) of each first solid section 313 as indicated at 320 (in a plane parallel to the longitudinal direction) may be greater than the size (i.e., width or diameter) of each corresponding light source 106 as indicated at 124 (in a plane parallel to the longitudinal direction). The size 320 of each first solid section 313 may be less than the size 124 of each corresponding light source 106 times a predetermined value. In certain exemplary embodiments, when the size 124 of the each light source 106 is greater than or equal to about 0.5 millimeters, the predetermined value may be about two or about three, such that the size of each first solid section 313 is less than three times the size of each light source 106. When the size 124 of each light source 106 is less than 0.5 millimeters, the predetermined value may be determined by the alignment capability between the light sources 106 and the patterned reflectors 312, such that the size of each first solid section 313 of each of patterned reflector 312 is within a range between about 100 micrometers and about 300 micrometers greater than the size of each light source 106. Each first solid section 313 is large enough such that each patterned reflector 312 can be aligned to the corresponding light source 106 and small enough to achieve suitable luminance uniformity and color uniformity.

Each patterned reflector 312 may be formed, for by printing (e.g., inkjet printing, screen printing, microprinting, etc.) a pattern with white ink, black ink, metallic ink, or other suitable ink. Each patterned reflector 312 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

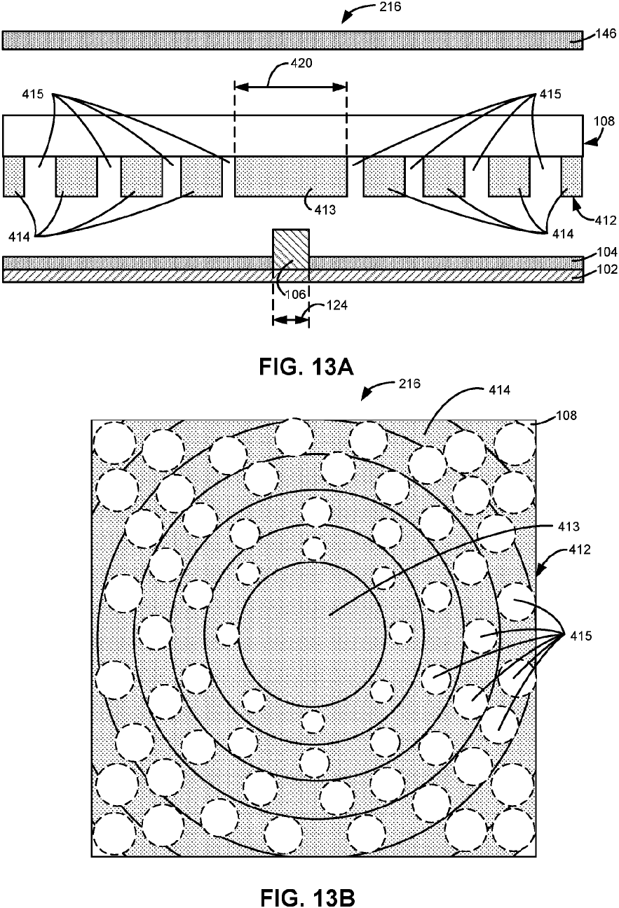

FIGS. 13A and 13B are various views of another exemplary backlight 216. FIG. 13A is a simplified cross-sectional view of backlight 216 and FIG. 13B is a bottom view of a patterned reflector 412 on a light guide plate 108. Backlight 216 is similar to backlight 200 previously described and illustrated with reference to FIG. 5, except that in backlight 216 patterned reflectors 412 are used in place of patterned reflectors 112. Backlight 216 may include a substrate 102, a reflective layer 104, a plurality of light sources 106, and a light guide plate 108 as previously described and illustrated with reference to FIGS. 1A-3C. Backlight 216 also includes the first layer 146 of an optical film stack (not shown) over the light guide plate 108.

Each patterned reflector 412 is on a first surface of the light guide plate 108, where the first surface of the light guide plate faces the plurality of light sources 106. In other embodiments, the first surface of the light guide plate 108 may face away from the plurality of light sources 106 such that the patterned reflectors 412 face away from the plurality of light sources 106. Each patterned reflector 412 includes a first solid section 413, a second section 414 surrounding the first solid section 413, and a plurality of openings 415 extending through the second section 414. As illustrated in FIG. 13B, the openings 415 increase in size (i.e., width or diameter) as a distance from the center of the solid first section 413 increases. Each opening 415 may be circular, elliptical, or another suitable shape. In other embodiments, the features of patterned reflectors 312 previously described and illustrated with reference to FIGS. 12A and 12B may be combined with the features of patterned reflectors 412 to form patterned reflectors including both ring-like openings (e.g., 315) and discrete openings (e.g., 415).

The size L0 (i.e., width or diameter) of each first solid section 413 as indicated at 420 (in a plane parallel to the longitudinal direction) may be greater than the size (i.e., width or diameter) of each corresponding light source 106 as indicated at 124 (in a plane parallel to the longitudinal direction). The size 420 of each first solid section 413 may be less than the size 124 of each corresponding light source 106 times a predetermined value. In certain exemplary embodiments, when the size 124 of the each light source 106 is greater than or equal to about 0.5 millimeters, the predetermined value may be about two or about three, such that the size of each first solid section 413 is less than three times the size of each light source 106. When the size 124 of each light source 106 is less than 0.5 millimeters, the predetermined value may be determined by the alignment capability between the light sources 106 and the patterned reflectors 112, such as a predetermined value of about 100, 200, or 300 micrometers. Each first solid section 413 is large enough such that each patterned reflector 412 can be aligned to the corresponding light source 106 and small enough to achieve suitable luminance uniformity and color uniformity.

Each patterned reflector 412 may be formed, for example, by printing (e.g., inkjet printing, screen printing, microprinting, etc.) a pattern with white ink, black ink, metallic ink, or other suitable ink. Each patterned reflector 412 may also be formed by first depositing a continuous layer of a white or metallic material, for example by physical vapor deposition (PVD) or any number of coating techniques such as for example slot die or spray coating, and then patterning the layer by photolithography or other known methods of area-selective material removal.

FIG. 14 is a simplified cross-sectional view of another exemplary backlight 230. Backlight 230 is similar to backlight 100 previously described and illustrated with reference to FIGS. 1A-3C, except that backlight 230 include an encapsulation layer 510. Backlight 230 also includes the first layer 146 of an optical film stack (not shown) over the encapsulation layer 510. In this embodiment, the encapsulation layer 510 is on the light guide plate 108 and encapsulates each of the plurality of patterned reflectors 112. In other embodiments, the plurality of patterned reflectors 312 previously described and illustrated with reference to FIGS. 12A-12B or the plurality of patterned reflectors 412 previously described and illustrated with reference to FIGS. 13A-13B may be used in place of the plurality of patterned reflectors 112. Encapsulation layer 510 may prevent damage (e.g., scratches) to each patterned reflector 112 due to potential contact with the quantum dot film, diffuser sheet, or diffuser plate 146 during fabrication of the backlight 230. Encapsulation layer 510 may also improve the adhesion of each patterned reflector 112 to the light guide plate 108.

FIG. 15 is a simplified cross-sectional view of another exemplary backlight 232. Backlight 232 is similar to backlight 200 previously described and illustrated with reference to FIG. 5, except that backlight 232 includes an encapsulation layer 510. In this embodiment, the encapsulation layer 510 is on the lower surface of the light guide plate 108 and encapsulates each of the plurality of patterned reflectors 112. In other embodiments, the plurality of patterned reflectors 312 previously described and illustrated with reference to FIGS. 12A-12B or the plurality of patterned reflectors 412 previously described and illustrated with reference to FIGS. 13A-13B may be used in place of the plurality of patterned reflectors 112. In this embodiment, encapsulation layer 510 may prevent damage (e.g., scratches) to each patterned reflector 112 due to potential contact with the light sources 106 during fabrication of the backlight 232.

Encapsulation layer 510 may be an optically clear adhesive, a clear resin, a diffusive resin, or another suitable material. Encapsulation layer 510 may be thermally curable, UV curable, or pressure sensitive. While encapsulation layer 510 fully encapsulates each patterned reflector 112 in the embodiment illustrated in FIGS. 14 and 15, in other embodiments encapsulation layer 510 may partially encapsulate each patterned reflector 112 such that a portion of each patterned reflector 112 remains exposed.

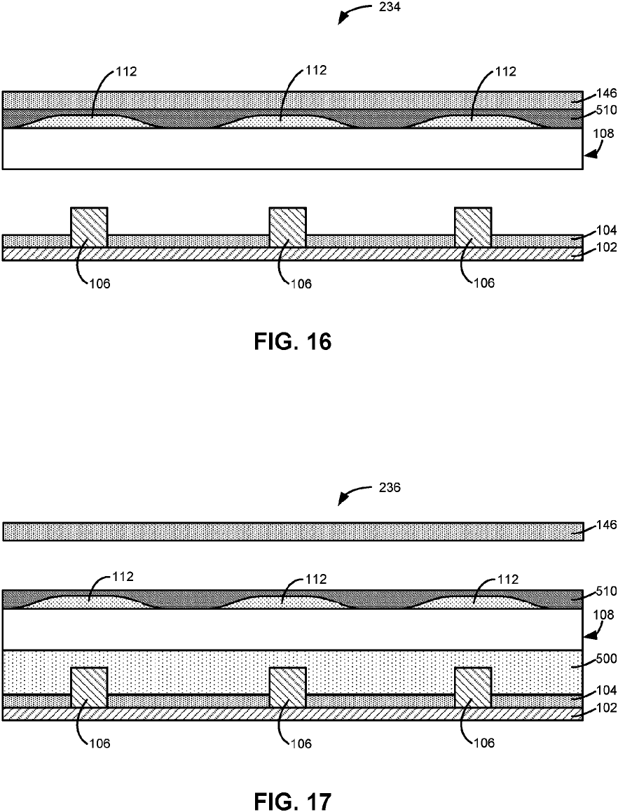

FIG. 16 is a simplified cross-sectional view of an exemplary backlight 234. Backlight 234 is similar to backlight 230 previously described and illustrated with reference to FIG. 14, except that in backlight 234 the encapsulation layer 510 is bonded to the first layer 146 of the optical film stack. The encapsulation layer 510 may be directly bonded to the first layer 146 of the optical film stack or bonded to the first layer 146 of the optical film stack via an adhesive material or another suitable material. By bonding the encapsulation layer 510 to the first layer 146 of the optical film stack, the overall thickness of the backlight 234 may be reduced and/or the mechanical stability of the backlight 234 may be improved.

FIG. 17 is a simplified cross-sectional view of an exemplary backlight 236. Backlight 236 is similar to backlight 230 previously described and illustrated with reference to FIG. 14, except that backlight 236 includes an encapsulation layer 500. The light guide plate 108 may be directly bonded to the encapsulation layer 500 or bonded to the encapsulation layer 500 via an adhesive material or another suitable material. By bonding the light guide plate 108 to the encapsulation layer 500, the overall thickness of the backlight 236 may be reduced and/or the mechanical stability of the backlight 236 may be improved.

As shown in FIGS. 17, 18, 20, and 21, the encapsulation layer 500 encapsulates each of the plurality of light sources 106. The encapsulation layer 500 may include a clear resin material, a silicone, or another suitable material. The clear resin material, silicone, or another suitable material should have a transmittance of over about 60 percent and preferably over about 90 percent. The encapsulation layer 500 may include nano-sized or micro-sized scattering particles.

FIG. 18 is a simplified cross-sectional view of an exemplary backlight 238. Backlight 238 is similar to backlight 236 previously described and illustrated with reference to FIG. 17, except that backlight 238 includes a diffusive layer 130 as previously described and illustrated with reference to FIG. 6 bonded between the light guide plate 108 and the encapsulation layer 500.

FIG. 19 is a simplified cross-sectional view of an exemplary backlight 240. Backlight 240 is similar to backlight 232 previously described and illustrated with reference to FIG. 15, except that backlight 240 includes a diffusive layer 130 bonded between the light guide plate 108 and the first layer 146 of the optical film stack.

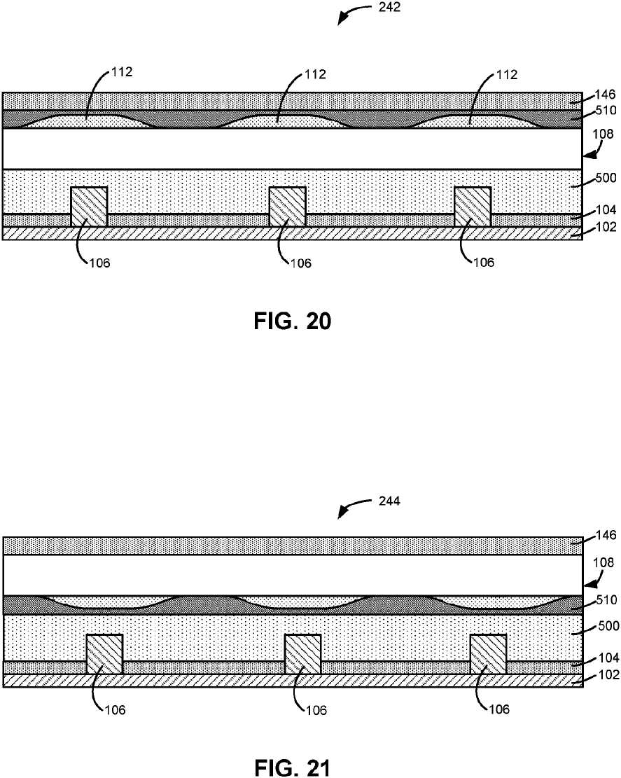

FIG. 20 is a simplified cross-sectional view of an exemplary backlight 242. Backlight 242 is similar to backlight 236 previously described and illustrated with reference to FIG. 17, except that in backlight 242 the encapsulation layer 510 is bonded to the first layer 146 of the optical film stack. By bonding the light guide plate 108 to the encapsulation layer 500 and by bonding the encapsulation layer 510 to the first layer 146 of the optical film stack, the overall thickness of the backlight 242 may be reduced and/or the mechanical stability of the backlight 242 may be improved.

FIG. 21 is a simplified cross-sectional view of an exemplary backlight 244. Backlight 244 is similar to backlight 232 previously described and illustrated with reference to FIG. 15, except that backlight 244 includes an encapsulation layer 500, the light guide plate 108 is bonded to the first layer 146 of the optical film stack, and the encapsulation layer 510 is bonded to the encapsulation layer 500. By bonding the light guide plate 108 to the first layer 146 of the optical film stack and by bonding the encapsulation layer 510 to the encapsulation layer 500, the overall thickness of the backlight 244 may be reduced and/or the mechanical stability of the backlight 244 may be improved. Similar to FIG. 19, the light guide plate 108 may have a diffusive layer 130 on the upper surface and be bonded to the first layer 146 of the optical film stack through the diffusive layer 130, while the encapsulation layer 510 is bonded to the encapsulation layer 500.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A backlight comprising:
a plurality of light sources coupled to a substrate; and
a patterned diffuser over the plurality of light sources, said patterned diffuser comprising a plurality of patterned reflectors coupled to a patterned diffuser body, each patterned reflector aligned with a corresponding light source,
wherein the backlight extends along a longitudinal direction,
wherein the substrate has a maximum longitudinal substrate dimension (L_{Max,S}) and the patterned diffuser body has a maximum longitudinal patterned diffuser body dimension (L_{Max,PDB}), each of L_{Max,S} and L_{Max,PDB}, respectively, in the longitudinal direction,
wherein a thermal alignment tolerance in the longitudinal direction at 60° C. is 500 microns or less, and
wherein the thermal alignment tolerance at 60° C. is the absolute value of [the smaller of L_{Max,S} and L_{Max,PDB}] × [60° C. - 23.5° C. (room temperature)] × [substrate coefficient of thermal expansion (CTEs) - patterned diffuser body coefficient of thermal expansion (CTE_{PDB})].

2. The backlight as claimed in claim 1, wherein the patterned diffuser body comprises a material selected from the group consisting of a glass, glass-ceramic, polymer, ceramic, and combinations thereof.

3. The backlight as claimed in claim 1, wherein the thermal alignment tolerance in the longitudinal direction at 60° C. is 300 microns or less.

4. The backlight as claimed in claim 1, wherein the thermal alignment tolerance in the longitudinal direction at the 60° C. is 200 microns or less.

5. The backlight as claimed in claim 1, wherein at least one of L_{Max,S} and L_{Max,PDB} is at least 0.5 meters.

6. The backlight as claimed in claim 1, wherein at least one of L_{Max,S} and L_{Max,PDB} is at least 1.0 meter.

7. The backlight as claimed in claim 1, wherein the backlight comprises at least two substrates extending along the longitudinal direction.

8. The backlight as claimed in claim 1, wherein the backlight comprises at least two patterned diffuser bodies extending along the longitudinal direction.

9. The backlight as claimed in claim 1, wherein the backlight comprises one substrate and one patterned diffuser body extending along the longitudinal direction and L_{Max,S} = L_{Max,PDB} > 0.5 meters.

10. The backlight as claimed in claim 1, wherein the substrate and the patterned diffuser body are both comprise glass.

11. The backlight as claimed in claim 1, wherein the substrate and the patterned diffuser body are both comprise plastic.

12. The backlight as claimed in claim 1, wherein the substrate and the patterned diffuser body are both comprise the same material.

13. The backlight as claimed in claim 1, wherein a ratio L1/P is within a range from about 0.45 and about 1, where L1 is a size of each patterned reflector of the plurality of patterned reflectors in a plane parallel to the longitudinal direction and P is a pitch of the plurality of light sources.

14. The backlight as claimed in claim 1, further comprising a first reflective layer on the substrate.

15. The backlight as claimed in claim 1, wherein the plurality of patterned reflectors are on a first surface of the patterned diffuser body.

16. The backlight as claimed in claim 15, further comprising:
a diffusive layer on a second surface of the patterned diffuser body opposite to the first surface.

17. The backlight as claimed in claim 16, further comprising:
a first layer of an optical film stack over the patterned diffuser body,
wherein the diffusive layer is bonded to the first layer of the optical film stack.

18. The backlight as claimed in claim 16, wherein the first surface faces the substrate.

19. The backlight as claimed in claim 16, wherein the second surface faces the substrate.

20. The backlight as claimed in claim 1, further comprising:
at least one encapsulation layer encapsulating the plurality of light sources.

21. The backlight as claimed in claim 1, wherein the plurality of patterned reflectors each comprise a metallic ink.

22. The backlight as claimed in claim 1, further comprising:
an encapsulation layer encapsulating the plurality of patterned reflectors.

23. The backlight as claimed in claim 1, wherein each light source has a size measured in a plane parallel to the longitudinal, and
wherein each patterned reflector has a thickness profile, the thickness profile comprising a substantially flat section and a curved section extending from and surrounding the substantially flat section, the substantially flat section varying in thickness by no more than plus or minus about 20 percent of an average thickness of the substantially flat section, and the substantially flat section comprising a size in a plane parallel to the longitudinal equal to or greater than the size of each light source.

24. The backlight as claimed in claim 23, wherein the size of each substantially flat section of each of the plurality of patterned reflectors is less than about three times the size of each light source of the plurality of light sources.

25. The backlight as claimed in claim 24, wherein the size of each substantially flat section of each of the plurality of patterned reflectors is within a range between about 100 micrometers and about 300 micrometers greater than the size of each light source of the plurality of light sources.

26. The backlight as claimed in claim 24, wherein each substantially flat section of each of the plurality of patterned reflectors varies in thickness by no more than plus or minus about 10 percent of the average thickness of the corresponding substantially flat section.

27. The backlight as claimed in claim 1, wherein each light source has a size measured in a plane parallel to the longitudinal direction, and
wherein each patterned reflector comprises a first solid section, a plurality of second solid sections surrounding the first solid section, and a plurality of open sections interleaved with the plurality of second solid sections, the first solid section comprising a size in a plane parallel to the longitudinal direction equal to or greater than the size of each light source.

28. The backlight as claimed in claim 27, wherein an area ratio A(r) of each second solid section equals As(r) / (As(r) + Ao(r)), where r is the distance from a center of the corresponding patterned reflector, As(r) is the area of the corresponding second section, and Ao(r) is the area of the corresponding open section, and the area ratio A(r) of each second solid section decreases with the distance r, and a rate of the decrease decreases with the distance r.

29. The backlight as claimed in claim 1, wherein each light source has a size measured in a plane parallel to the longitudinal direction; and
wherein each patterned reflector comprises a solid first section, a second section surrounding the solid first section, and a plurality of openings extending through the second section, the openings increasing in size as a distance from a center of the solid first section increases, and the solid first section comprising a size in a plane parallel to the longitudinal direction equal to or greater than the size of each light source.

30. The backlight as claimed in claim 29, wherein each of the plurality of openings comprises a circular or elliptical opening.
